(19) United States
(12) Patent Application Publication
(10) Pub. No.: US 2010/0289620 A1
(43) Pub. Date: Nov. 18, 2010

(54) CONNECTIONLESS LOCATION IDENTIFICATION WITHIN A SERVER SYSTEM

(75) Inventors: Hans-Juergen Aminger, Ebersback (DE); Dirk Bolte, Gaertringen (DE); Herwig Elfering, Boeblingen (DE); Adolf Martens, Weil im Schoenbuch (DE)

Correspondence Address: DILLON & YUDELL LLP, 8911 N. CAPITAL OF TEXAS HWY, SUITE 2110, AUSTIN, TX, 78759, US

(73) Assignee: INTERNATIONAL BUISNESS MACHINES CORPORATION, Armonk, NY (US)

(21) Appl. No.: 12/466,148

(22) Filed: May 14, 2009

(51) Int. Cl. H04Q 5/22

(52) U.S. Cl. 340/10.1

(57) ABSTRACT

A method, system, and computer program product for determining connectionless location identification information of devices within a server system. A Radio Frequency Identification (RFID) Controller within the server system transmits a location request to a RFID Sensor. The RFID Sensor identifies devices in the server system and returns signal strength and location information of the devices to the Embedded Controller. The Embedded Controller calculates its own current location. Signal strength information is interpreted by the Embedded Controller to calculate location information. After calculating its own current location, the Embedded Controller locally stores the current location. The location information is subsequently transmitted to a Support element. The Support Element calculates a fix IP address for the Embedded Controller based on the location information, and assigns the IP address to the Embedded Controller. The location information is used for later communication with that Embedded Controller.

### BACKGROUND OF THE INVENTION

1. Technical Field

The present invention relates in general to data processing systems, and in particular to positioning sensing in a data processing system. Still more particularly, the present invention relates a system for determining connectionless location identification of devices within a server system.

2. Description of the Related Art

A data processing system can be configured with different devices, such as cages, drawers, and cards to enable increased functionality of a server system. Topology sensing is the determination of how the devices are interconnected. Location sensing may be used identify devices plugged into a data processing system and the specific location where these devices are connected. Each device is assigned a unit ID by the manufacturer. Unit IDs can be unique within a particular system, or even unique for all systems. For example, Ethernet Media Access Control (MAC) addresses are unique for all systems.

The position of a device within a system may be uniquely important. When a device fails an engineer requires the location of the device in order to substitute in a replacement. Existing cage/drawer systems have limited flexibility because a seeding has to be updated for each cage/drawer. This exposes the server system to user errors. Additionally, when seeding is based on plugs in a drawer and frame, there is a high risk of damaging a component board or a connection on the component board of a cage or drawer when inserting the cage drawer into the frame. Configuring and subsequently determining the position of a device within a data processing system can require a substantial amount of effort on part of an engineer or a technician.

### SUMMARY OF THE INVENTION

Disclosed is a method, system, and computer program product for determining connectionless location identification information of devices within a server system. A Radio Frequency Identification (RFID) Controller within the server system transmits a location request to a RFID Sensor. The RFID Sensor identifies devices in the server system and returns signal strength and location information of the devices to the Embedded Controller. The Embedded Controller calculates its own current location. Signal strength information is interpreted by the Embedded Controller to calculate location information. After calculating its own current location, the Embedded Controller locally stores the current location. The location information is subsequently transmitted to a Support element. The Support Element calculates a fix IP address for the Embedded Controller based on the location information, and assigns the IP address to the Embedded Controller. The location information is used for later communication with that Embedded Controller.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, will best be understood by reference to the following detailed descriptions of an illustrative embodiment when read in conjunction with the accompanying drawings, wherein:

FIG. 1 is a block diagram of a data processing system with a Embedded Controller in which the present invention may be implemented.

FIG. 2 is a block diagram of an exemplary system for determining connectionless location identification information of devices within a server system, in accordance with one embodiment of the invention.

FIG. 3 is a high-level logical flowchart of an exemplary method for determining connectionless location identification information of devices within a server system, in accordance with one embodiment of the invention.

### DETAILED DESCRIPTION OF THE PREFERRED EMBODIMENT

The illustrative embodiments provide a method, system, and computer program for determining location identification information of devices within a server system, in accordance with one embodiment of the invention.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit nor scope of the present invention. The following detailed description is, therefore, not to be taken in a limiting sense, and the scope of the present invention is defined only by the appended claims.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

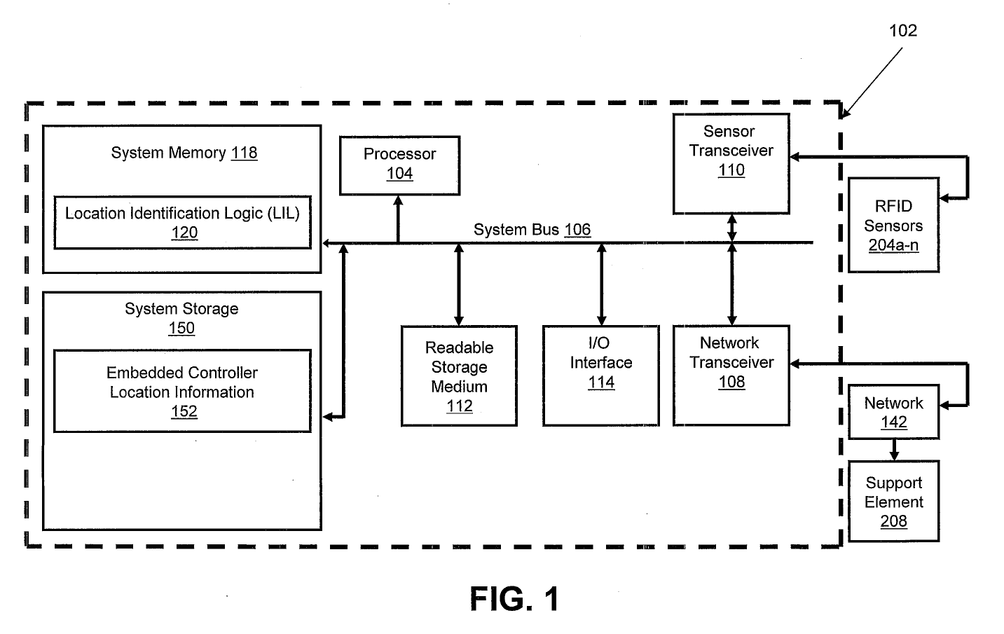

With reference now to FIG. 1, there is depicted a block diagram of a data processing system with a Radio Frequency Identification (RFID) Controller 102 in which the present invention may be implemented. Embedded Controller 102 includes a processor 104 that is coupled to a system bus 106. A network transceiver 108, connected to system bus 106, enables Embedded Controller 102 to connect through network 142 to Support Element 208, via wired or wireless mechanisms. A sensor transceiver 110, connected to system bus 106, enables Embedded Controller 102 to connect to RFID Sensors 204a-n, via wired or wireless mechanisms, for receiving location and signal strength information from RFID tags in a server system. In an alternate embodiment an RFID sensor 204a-n may be implemented within the Embedded Controller 102. System bus 106 also affords communication with a hardware-based readable storage medium 112 (e.g., Compact Disk-Read Only Memory (CD-ROM), flash drive memory, etc). Input/Output (I/O) Interface 114, also connected to system bus 106, permits user interaction with Embedded Controller 102, such as data entry via keyboard or mouse (not pictured).

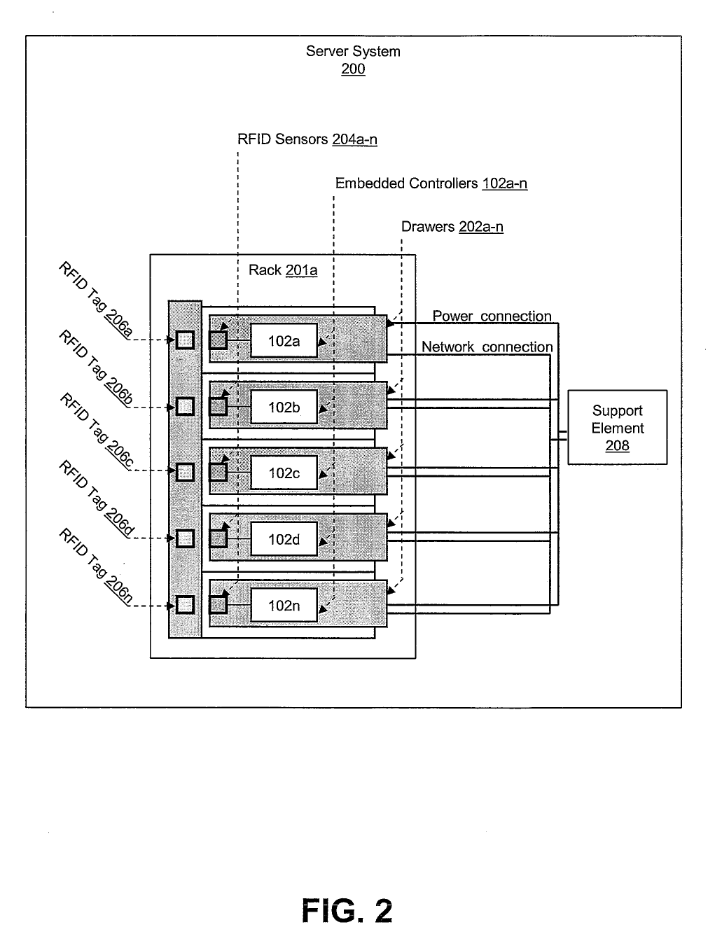

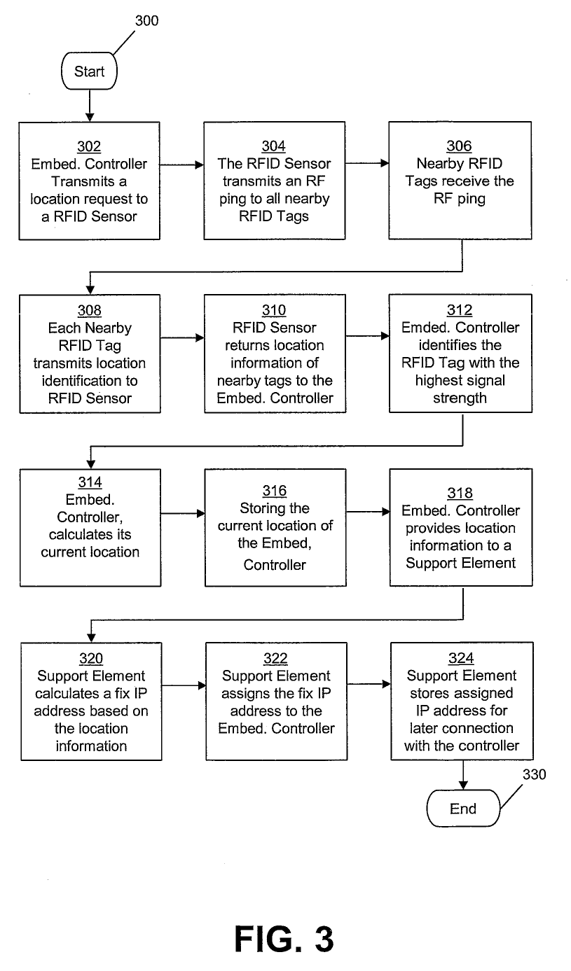

Embedded Controller 102 also comprises system memory 118, which is connected to system bus 106. As shown, system memory 118 also comprises Location Identification Logic (LIL) 120 for determining the location of devices within the server system. LIL 120 includes code for implementing the processes described in FIGS. 2-3. In one embodiment, Embedded Controller 102 is able to utilize LIL 120 to determine connectionless location identification information of devices within a server system, as described in greater detail below in FIGS. 2-3.

Embedded Controller 102 also comprises a system storage 150, which is connected to system bus 106. System Storage 150 comprises Embedded Controller Location Information 152 for storing the determined location of the Embedded Controller.

As illustrated and described herein, Embedded Controller 102 may be a computer or computing device having the required hardware components and programmed with LIL 120, executing on the processor to provide the functionality of the invention. The hardware elements depicted in Embedded Controller 102 are not intended to be exhaustive, but rather are representative to highlight essential components required by and/or utilized to implement the present invention. For instance, Embedded Controller 102 may include alternate memory storage devices such as magnetic cassettes, Digital Versatile Disks (DVDs), Bernoulli cartridges, and the like. These alternate configurations of components and other variations are intended to be within the spirit and scope of the present invention.

With reference now to FIG. 2, there is illustrated an exemplary system for determining connectionless location identification information of devices within a server system, in accordance with one embodiment of the invention. Server system 200 includes one or more racks 201a-n. Each server rack contains one or more drawers 202a-n, and each drawer 202a-n may contain one or more server devices (e.g., computer components, component printed wiring boards (PWBs) and/or peripherals of the server system). In an alternate embodiment the drawers may also be cages or blades. Each drawer 202a-n contains an Embedded Controller 102a-n and a RFID Sensor 204a-n for determining the location of the device.

The Embedded Controller 102a-n, issues a location request to an RFID Sensor 204a-n to determine the location of the device located within the drawer 202a-n. Upon receiving the location request, the RFID sensor transmits a radio frequency (RF) ping to nearby RFID Tags 206a-n. Each RFID Tag 206 corresponds to a connection location within the server system. In one embodiment, each RFID Tag 206a-n may have a unique predefined identification associated with the position of that RFID Tag 206a-n. When a RFID Tag 206 receives the RF ping, the RFID Tag 206 responds by transmitting a unique location identification to the transmitting RFID Sensor 204a-n. The location identification includes a frame location and a position location of that specific RFID Tag 206. The RFID Sensor 204a-n relays a signal strength and received location information of each responding RFID tag 206a-n to the Embedded Controller 102a-n.

The Embedded Controller 102a-n receives and interprets the signal strength and location information from the RFID Sensor 204a-n to calculate location information. The Embedded Controller 102a-n is then able to calculate its current location from the received signal strength and location data. The current location of the Embedded Controller is locally stored in persistent storage (e.g., Embedded Controller Location Information 152 of system storage 150). The location information is then transmitted to Support Element 208.

The Support Element 208 governs interaction of the server system with devices in Drawers 202a-n. The Support Element 208 in response to receiving the location information of Embedded Controller 102 may calculate a unique fix IP address based on the current location of a particular Embedded Controller 102. The fix IP address may be unique within that Server System 200. Every controller has a unique physical location. Accordingly, the IP address is also unique. A scheme for assigning the fix IP address may also be the identical in every Server System 200. In this embodiment, when Embedded Controller 102a-n transmits a request with the same location information, it is always assigned the same fix IP address from Support Element 208. The unique IP address of Embedded Controller 102a-n is locally saved on the support element for subsequent communications with that Embedded Controller 102.

With reference now to FIG. 3, a high-level logical flowchart of an exemplary method for determining connectionless location identification information of devices within a server system is presented. After initiator block 300, the Embedded Controller transmits a location request to a RFID Sensor (block 302). Upon receiving the location request, the RFID Sensor transmits an RF ping receivable only by nearby RFID tags (block 304). At block 306, the nearby RFID Tags receive the RFID ping. The nearby RFID Tags respond by returning location information (e.g., frame location, position location) (block 308). The RFID Sensor then determines the signal strength of each responding RFID Tag and returns the signal strength and location information of each responding RFID Tag to the Embedded Controller (block 310). At block 312, the Embedded Controller identifies the RFID Tag with the highest signal strength. The RFID Tag with the highest signal strength is expected to be the nearest RFID tag. The Embedded Controller then calculates its own current position based on the received location information (block 314), and locally stores the current location to persistent storage (block 316).

At block 318, the Embedded Controller provides the signal strength and location information of the RFID tags and location information of the Embedded Controller to a support element. The support element calculates a fix IP address based on the received location information (block 320) and assigns the fix IP address to the Embedded Controller (block 322). The support element then locally stores the assigned IP address of the Embedded Controller for subsequent communication with the Embedded Controller and with any device(s) in the same drawer location as the Embedded Controller (block 324). The process then ends at terminator block 330.

Although aspects of the present invention have been described with respect to a computer processor and program application/logic, it should be understood that at least some aspects of the present invention may alternatively be implemented as a program product for use with a data storage system or computer system. Programs defining functions of the present invention can be delivered to a data storage system or computer system via a variety of signal-bearing media, which include, without limitation, non-writable storage media (e.g. CD-ROM), writable storage media (e.g. a floppy diskette, hard disk drive, read/write CD-ROM, optical media), and communication media, such as computer and telephone networks including Ethernet. It should be understood, therefore, that such signal-bearing media, when carrying or encoding computer readable instructions that direct method functions of the present invention, represent alternative embodiments of the present invention. Further, it is understood that the present invention may be implemented by a system having means in the form of hardware, software, or a combination of software and hardware as described herein or their equivalent. Additionally, the present invention may be implemented in a machine in the form of a computer-readable storage medium having a plurality of instructions embodied executing on a processing device.

Having thus described the invention of the present application in detail and by reference to illustrative embodiments thereof, it will be apparent that modifications and variations are possible without departing from the scope of the invention defined in the appended claims. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method of determining connectionless location identification information of devices within a server system, the method comprising:
at an Embedded Controller, issuing a location request to a Radio Frequency Identification (RFID) Sensor;
receiving signal strength and location information from the RFID Sensor, wherein the signal strength and location information includes signal strength and location information of one or more nearby Radio Frequency Identification (RFID) tags;
calculating, the current location of the Embedded Controller from the received signal strength and location information;
in response to calculating the current location of the Embedded Controller, locally storing, on the Embedded Controller, the current location of the Embedded Controller; and
providing, to a support element, the location information and the current location of the Embedded Controller.

2. The method of claim 1, wherein the location request enables the RFID Sensor to perform the steps of:
at the RFID Sensor, transmitting a radio frequency (RF) ping to nearby RFID tags, wherein a RFID tag corresponds to a connection location within the server system,
receiving a location identification from the nearby RFID tags, wherein the location identification includes a frame location and a position location, and
transmitting signal strength and location information of the nearby RFID tags to the Embedded Controller.

3. The method of claim 1, further comprising:
receiving, at the support element, the signal strength and location information of the one or more RFID tags and the current location of the Embedded Controller, wherein the signal strength and location information of the one or more RFID tags and the current location of the Embedded Controller enables the support element to perform the steps of:
calculating a unique fix IP address based on the current location of the Embedded Controller,
assigning the unique fix IP address to the Embedded Controller, and
storing the unique IP address of the Embedded Controller for subsequent communications with the Embedded Controller.

4. An Embedded Controller comprising:
a processor;
a transceiver;
a Radio Frequency Identification (RFID) Sensor a memory coupled to the processor;
processing logic executing on the processor for enabling the Embedded Controller to perform the steps of:
at the Embedded Controller, issuing a location request to a Radio Frequency Identification (RFID) Sensor;
receiving a signal strength and location information from the RFID Sensor, wherein the signal strength and location information includes signal strength and location information of one or more nearby Radio Frequency Identification (RFID) tags;
calculating, the current location of the Embedded Controller from the received signal strength and location information;
in response to calculating the current location of the Embedded Controller, locally storing, on the Embedded Controller, the current location of the Embedded Controller; and
providing, to a support element, the location information and the current location of the Embedded Controller.

5. The RFID Sensor of claim 4, wherein the location request enables the RFID Sensor to perform the steps of:
transmitting a radio frequency (RF) ping to nearby RFID tags, wherein a RFID tag corresponds to a connection location within the server system,
receiving a location identification from nearby RFID tags, wherein the location identification includes a frame location and a position location, and
transmitting signal strength and location information of the nearby RFID tags to the Embedded Controller.

6. The Embedded Controller of claim 4, further comprising:
receiving, at the support element, the signal strength and location information of the one or more RFID tags and the current location of the Embedded Controller, wherein the signal strength and location information of the one or more RFID tags and the current location of the Embedded Controller enables the support element to perform the steps of:
calculating a unique fix IP address based on the current location of the Embedded Controller,
assigning the unique fix IP address to the Embedded Controller, and
storing the unique IP address of the Embedded Controller for subsequent communications with the Embedded Controller.

7. A computer-readable storage medium having a plurality of instructions embodied therein, wherein the plurality of instructions, when executed by a processing device, allows a machine to:
at an Embedded Controller, issue a location request to a Radio Frequency Identification (RFID) Sensor;
receive a signal strength and location information from the RFID Sensor, wherein the signal strength and location information includes signal strength and location information of one or more nearby Radio Frequency Identification (RFID) tags;
calculate, the current location of the Embedded Controller from the received signal strength and location information;
in response to calculating the current location of the Embedded Controller, locally store, on the Embedded Controller, the current location of the Embedded Controller; and
provide, to a support element, the location information and the current location of the Embedded Controller.

8. The computer-readable storage medium of claim 7, wherein the location request enables the RFID Sensor to:
at the RFID Sensor, transmit a radio frequency (RF) ping to nearby RFID tags, wherein a RFID tag corresponds to a connection location within the server system,
receive a location identification from nearby RFID tags, wherein the location identification includes a frame location and a position location, and
transmit signal strength and location information of the nearby RFID tags to the Embedded Controller.

9. The computer-readable storage medium of claim 7, wherein the recorded demonstration simulation further comprises instructions for enabling the machine to perform the steps of:
receive, at the support element, the signal strength and location information of the one or more RFID tags and the current location of the Embedded Controller, wherein the signal strength and location information of the one or more RFID tags and the current location of the Embedded Controller enables the support element to:
calculate a unique fix IP address based on the current location of the Embedded Controller,
assign the unique fix IP address to the Embedded Controller, and
store the unique IP address of the Embedded Controller for subsequent communications with the Embedded Controller.
